(19) United States
(12) Patent Application Publication
(10) Pub. No.: US 2004/0114070 A1
(43) Pub. Date: Jun. 17, 2004

(54) LIQUID CRYSTAL DISPLAY MODULE

(76) Inventor: Hsin-Tao Huang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,852

(22) Filed: May 13, 2003

(30) Foreign Application Priority Data
Dec. 12, 2002 (TW) 091136015

(51) Int. Cl. G02F 1/1333

(52) U.S. Cl. 349/96

(57) ABSTRACT

A liquid crystal display module (LCD module) has a LCD panel, a back light unit (BLU) and a bezel. The LCD panel has a substrate and a first polarizer fixed on the substrate, and the back light unit has a light guide plate, a light source generator, a reflector, a lower diffuser; at least one prism sheet, an upper diffuser, a second polarizer and a P-chassis.

### BACKGROUND OF INVENTION

1. Field of the Invention

The present invention relates to a liquid crystal display (LCD) module, and more specifically, to a LCD module with a polarizer utilized as either a polarizer or a diffuser.

2. Description of the Prior Art

Backlight units are known in the art. The backlight unit, which is a key element in the fabrication of liquid crystal displays, is widely used in digital cameras, PDAs, vehicle satellite navigation systems, computer monitors, flat panel TVs and so on. Typically, a backlight unit, which is generally installed underneath a display panel, comprises a light source (or multiple light sources) and a light diffusion means for providing users and consumers with diffused, ample, and comfortable backlighting. Light penetrates the overlying display panel and forms various images controlled by pixel electrodes densely arranged on the display panel. Backlight units are typically divided into two major categories: edge light type and direct-type, wherein the direct-type backlight unit can provide higher intensity of light and is thus more suited for large size display panels, such as display panels or TV panels, than the edge light type.

Please refer to FIG. 1 of a schematic view of a liquid crystal display (LCD) module 10 according to the prior art. As shown in FIG. 1, the LCD module 10 comprises a LCD panel 11 and a back light unit 21, which are assembled by a bezel (not shown).

Please refer to FIG. 2 of an enlarged schematic view of the LCD panel 11 shown in FIG. 1. As shown in FIG. 2, the LCD panel 11 comprises a substrate 12 with a top surface 12a and a bottom surface 12b, a first polarizer 14 fixed on the top surface 12a of the substrate 12, a plurality of tape carrier package (TCP) 16, which comprises multiple output terminals (not shown) connected to the substrate 12 and have multiple input terminals (not shown), a printed circuit board (PCB) 18, comprising circuits, connected to the multiple input terminals, and a second polarizer (not shown) fixed on the bottom surface 12b of the substrate 12 by an adhesion process utilizing a glue layer (not shown).

Please refer to FIG. 3 of an exploded view of the back light unit 21 shown in FIG. 1. As shown in FIG. 3, the back light unit 21 comprises a light guide plate (LGP) 22, a light source generator 24, a reflector 26, a lower diffuser 28, at least one prism sheet 30, an upper diffuser 32 and a P-chassis (not shown). The light source generator 24 is disposed on either side of the light guide plate 22 and is utilized for generating a light source (not shown), and the reflector 26 is disposed under the light guide plate 22 and is utilized for reflecting the light source to the light guide plate 22. The light guide plate 22 is utilized for scattering the light source to the lower diffuser 28, the prism sheet 30 and the upper diffuser 32, and the second polarizer is employed to polarize and further scatter the light source to the LCD panel 11 shown in FIG. 1 and FIG. 2. The lower diffuser 28, the prism sheet 30 and the upper diffuser 32 are sequentially disposed atop the light guide plate 32, and the P-chassis is disposed under the reflector 26 to surround the reflector 26.

However, the glue layer of the second polarizer itself absorbs and reflects the light source generated by the light source generator 24, therefore reducing the display efficiency of the LCD module 10. In addition, it is necessary to apply a pressure on the second polarizer during the adhesion process for fixing the second polarizer on the bottom surface 12b of the substrate 12 by the glue layer. This pressure applied frequently cause glue extrusion of the second polarizer that seriously defects the quality of the LCD module 10, reducing the production yield rate of the LCD module 10.

### SUMMARY OF INVENTION

It is therefore a primary object of the present invention to provide a liquid crystal display (LCD) module so as to improve the display efficiency and production yield rate of the LCD module.

According to the claimed invention, the LCD module comprises a LCD panel, a back light unit (BLU) and a bezel for assembling the LCD panel and the back light unit. The LCD panel comprises a substrate and a first polarizer fixed on the substrate, and the back light unit comprises a light guide plate (LGP), a light source generator disposed on either side of the light guide plate, a reflector disposed under the light guide plate, a lower diffuser disposed atop the light guide plate, at least one prism sheet disposed on a surface of the lower diffuser, an upper diffuser disposed atop the prism, a second polarizer disposed atop the upper diffuser, and a P-chassis disposed under the reflector to surround the reflector. The light source generator is utilized for generating a light source, and the second polarizer comprises at least one upper rough surface.

It is an advantage of the present invention against the prior art that the back light unit of the LCD module utilizes the upper and a lower rough surfaces of the second polarizer to prevent mura phenomenon caused by electrostatic discharge (ESD) attraction as well as glue extrusion occurred in the adhesion process performed in the prior art for fixing the second polarizer (not shown in prior art figures) on the bottom surface 12b of the substrate 12 by the glue layer (not shown in prior art figures) due to the pressure applied, so as to ensure the production yield rate of the LCD module. In addition, the lower rough surface of the second polarizer revealed in the present invention could more evenly scatter the light source to the LCD panel. The upper diffuser can be therefore neglected for simplicity of production and reduction of manufacturing cost, making the LCD module a more competitive product.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic view of a liquid crystal display module according to the prior art.

FIG. 2 is an enlarged schematic view of the LCD panel 11 shown in FIG. 1.

FIG. 3 is an exploded view of the back light unit 21 shown in FIG. 1.

FIG. 4 is the schematic view of a LCD module according to the present invention.

FIG. 5 are FIG. 7 of schematic views of forming the LCD panel 41 in FIG. 4 according to the present invention.

FIG. 8 is the exploded view of the back light unit 51 in FIG. 4.

FIG. 9 is the schematic view of the back light unit 51 in FIG. 4.

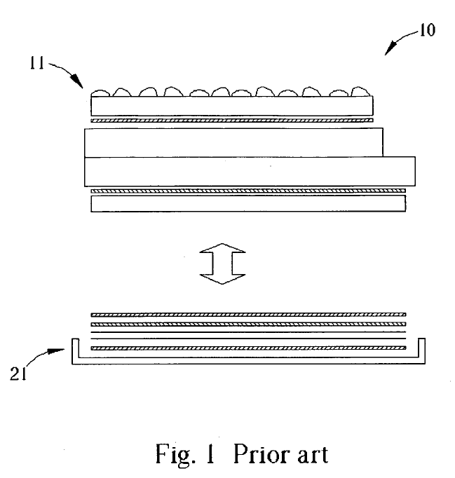

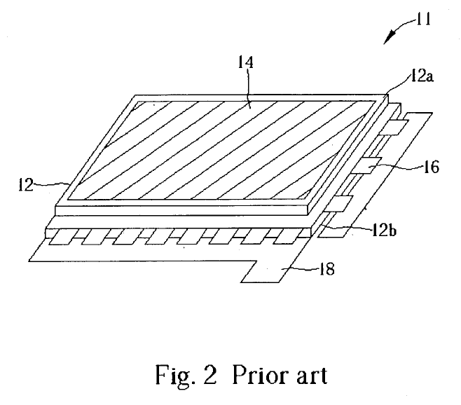

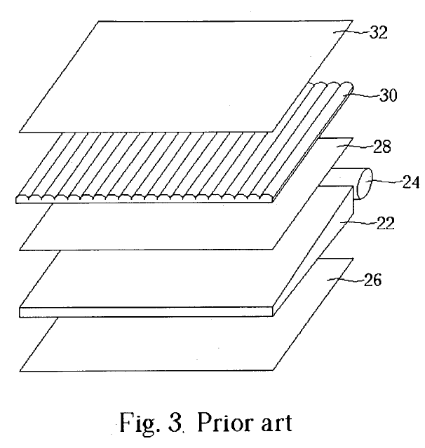

### DETAILED DESCRIPTION

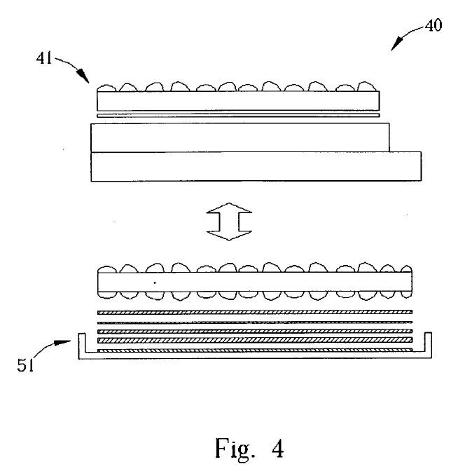

Please refer to FIG. 4 of a schematic view of a liquid crystal display (LCD) module 40 according to the present invention. As shown in FIG. 4, the LCD module comprises a LCD panel 41, a back light unit (BLU) 51 and a bezel (not shown) for assembling the LCD panel 41 and the back light unit 51.

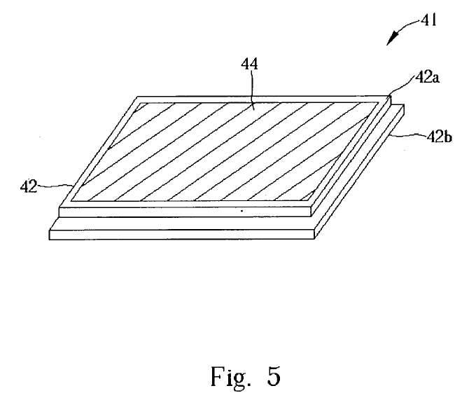

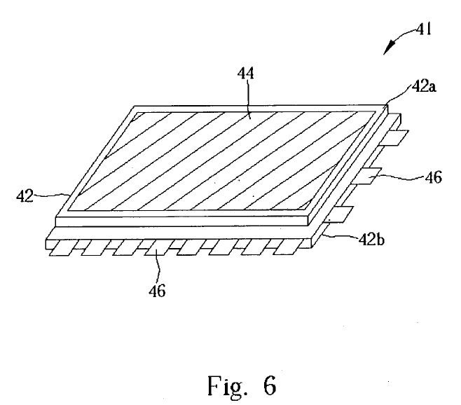

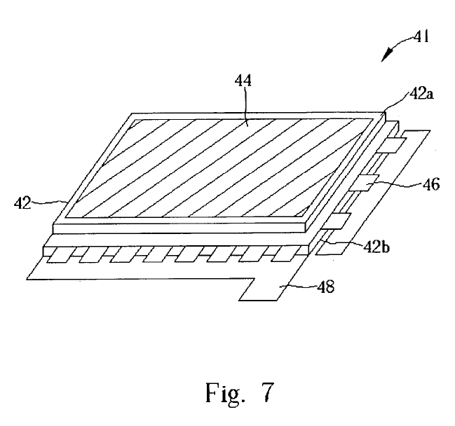

Please refer to FIG. 5 to FIG. 7 of schematic views of forming the LCD panel 41 according to the present invention. As shown in FIG. 5, the LCD panel comprises a substrate 42 with a top surface 42a and a bottom surface 42b. By performing an adhesion process, a first polarizer 44 comprising an adhesion glue is fixed on the top surface 42a of the substrate 42. As shown in FIG. 6, a tape carrier packaging bonding (TCP bonding) process is then performed to connect output terminals of a plurality of tape carrier packages (TCPs) 46 with the substrate 42. As shown in FIG. 7, a printed circuit board bonding (PCB bonding) process is performed to connect a PCB 48 comprising circuits with input terminals of the TCPs 46.

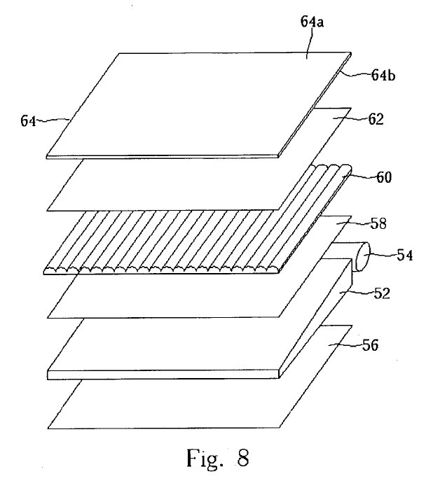

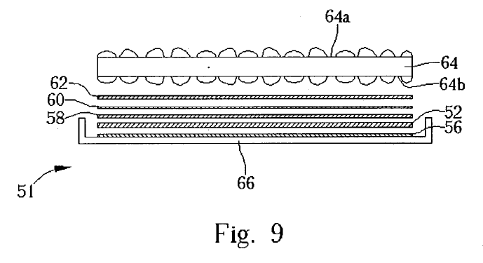

Please refer to FIG. 8 and FIG. 9, which respectively represent an exploded view and the schematic view of the back light unit 51 in FIG. 4. As shown in FIG. 8 and FIG. 9, the back light unit 51 comprises a light guide plate 52, a light source generator 54 (only shown in FIG. 8), a reflector 56, a lower diffuser 58, at least one prism sheet 60, an upper diffuser 62, a second polarizer 64 and a P-chassis 66 (not shown in FIG. 8).

The light source generator 54 is disposed on either side of the light guide plate 52, and is utilized for generating a light source. Alternatively, the light source generator 54 is disposed under the light guide plate according to specific product design. The reflector 56 is disposed under the light guide plate 52 and is utilized for reflecting the light source to the light guide plate 52. The light source is then scattered to the lower diffuser 58, the prism 60, the upper diffuser 62 and the second polarizer 64 by the light guide plate 52, polarized by the second polarizer 64, and transmitted to the LCD panel 41 shown in FIG. 4 to FIG. 7. The lower diffuser 58, the prism 60, the upper diffuser 62 and the second polarizer 64 are sequentially disposed atop the light guide plate 52, and the P-chassis 66 is disposed under the reflector 56 to surround the reflector 56. The second polarizer 64 comprises at least an upper rough surface 64a and a lower rough surface 64b. The upper rough surface 64a is utilized for preventing electrostatic discharge (ESD) attraction, and the lower rough surface 64b is employed to more evenly scatter the light source to the LCD panel 41 shown in FIG. 4 to FIG. 7. As the back light unit 51 and the LCD panel 41 are assembled by the bezel, the upper rough surface 64a and the lower rough surface 64b are respectively contacted with the bottom surface 42b of the substrate 42 shown in FIG. 5 to FIG. 7 and a surface of the upper diffuser 62.

In another embodiment of the present invention, the lower rough surface 64b of the second polarizer 64 is alternatively utilized for scattering the light source and functions as a diffuser, and the upper diffuser 62 is therefore neglected for simplicity of production and reduction of manufacturing cost. In still another embodiment of the present invention, the lower rough surface 64b of the second polarizer 64 can be neglected also for simplicity of production and reduction of manufacturing cost.

In comparison with the prior art, the back light unit 51 of the LCD module 40 utilizes the upper and lower rough surfaces 64a and 64b of the second polarizer 64 to prevent mura phenomenon caused by electrostatic discharge (ESD) attraction as well as glue extrusion occurred in the adhesion process performed in the prior art for fixing the second polarizer (not shown in prior art figures) on the bottom surface 12b of the substrate 12 by the glue layer (not shown in prior art figures) due to the pressure applied, so as to ensure the production yield rate of the LCD module 40. In addition, the lower rough surface 64b of the second polarizer 64 revealed in the present invention could more evenly scatter the light source to the LCD panel 41. The upper diffuser can be therefore neglected for simplicity of production and reduction of manufacturing cost, making the LCD module 40 a more competitive product.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A liquid crystal display (LCD) module comprising:
a LCD panel, the LCD panel comprising:
a substrate with a top surface and a bottom surface; and
a first polarizer fixed on the top surface of the substrate;
a back light unit (BLU), the back light unit comprising:
a light guide plate (LGP);
a light source generator for generating a light source;
a reflector disposed under the light guide plate;
a lower diffuser disposed atop the light guide plate;
at least one prism sheet disposed on a surface of the lower diffuser;
an upper diffuser disposed atop the prism;
a second polarizer disposed atop the upper diffuser, the second polarizer comprising at least one rough surface; and
a P-chassis disposed under the reflector to surround the reflector; and
a bezel.

2. The LCD module of claim 1 wherein the reflector is utilized for reflecting the light source to the light guide plate, and the light guide plate is utilized for scattering the light source to the lower diffuser, the prism and the upper diffuser.

3. The LCD module of claim 1 wherein the rough surface of the second polarizer is utilized for preventing a mura phenomenon caused by electrostatic discharge (ESD) attraction.

4. The LCD module of claim 3 wherein the first polarizer comprises an adhesion glue and is fixed on the top surface of the substrate by performing an adhesion process.

5. The LCD module of claim 1 wherein the light source generator is disposed on either side of the light guide plate.

6. The LCD module of claim 1 wherein the light source generator is disposed under the light guide plate.

7. The LCD module of claim 1 wherein the bezel is employed for assembling the LCD panel and the back light unit.

8. A LCD module comprising:
a LCD panel, the LCD comprising:
a substrate with a top surface and a bottom surface; and
a first polarizer adhered to the top surface of the substrate;
a back light unit, the back light unit comprising:
a light guide plate;
a light source generator for generating a light source;
a reflector disposed under the light guide plate;
a first diffuser disposed atop the light guide plate;
at least one prism sheet disposed on a surface of the first diffuser; and
a P-chassis disposed under the reflector to surround the reflector;
a second polarizer disposed between the LCD panel and the back light unit, the second polarizer comprising a first rough surface and a second rough surface; and
a bezel.

9. The LCD module of claim 8 wherein the light source generator is disposed on either side of the light guide plate.

10. The LCD module of claim 8 wherein the light source generator is disposed under the light guide plate.

11. The LCD module of claim 8 wherein the reflector is utilized for reflecting the light source to the light guide plate, and the light guide plate is utilized for scattering the light source to the first diffuser and the prism.

12. The LCD module of claim 8 wherein the first and second rough surfaces of the second polarizer are utilized for preventing a mura phenomenon caused by ESD attraction.

13. The LCD module of claim 8 wherein the second rough surface of the second polarizer is contacted with the prism of the back light unit.

14. The LCD module of claim 13 wherein the first polarizer comprises an adhesion glue and is fixed on the top surface of the substrate by performing an adhesion process.

15. The LCD module of claim 8 wherein the second rough surface of the second polarizer is utilized as a second diffuser.

16. The LCD module of claim 8 wherein the bezel is employed for assembling the LCD panel, the second polarizer and the back light unit.
